(19) United States
(12) Patent Application Publication
(10) Pub. No.: US 2004/0198123 A1
(43) Pub. Date: Oct. 7, 2004

(54) TWIN SHEET THERMOPLASTIC HEADLINER WITH INTEGRAL FEATURES FOR HEAD IMPACT COMPLIANCE

(75) Inventors: RONALD E. GILLINGHAM, DEARBORN HEIGHTS, MI (US); MICHAEL M. FILIPOVICH, WEST BLOOMFIELD, MI (US); ROBERT ARMITAGE, HOWELL, MI (US); JOSEPH B. FRENCH, DETROIT, MI (US)

Correspondence Address: DYKEMA GOSSETT PLLC, 2723 SOUTH STATE STREET, SUITE 400, ANN ARBOR, MI, 48104, US

(73) Assignee: FORD GLOBAL TECHNOLOGIES LLC, DEARBORN, MI (US)

(21) Appl. No.: 10/707,484

(22) Filed: Dec. 17, 2003

Related U.S. Application Data
(60) Provisional application No. 60/459,184, filed on Apr. 1, 2003.

(51) Int. Cl. D03D 15/00; D03D 25/00; B32B 3/10; D04H 5/00; D04H 3/00; D04H 1/00; D04H 13/00

(52) U.S. Cl. 442/327; 428/131; 428/134; 428/137

(57) ABSTRACT

A headliner for a vehicle and a method of manufacturing the same is provided. The method includes providing vacuum forming equipment including upper and lower mold halves, providing thermoplastic material including a top and an independent bottom layer, and placing the top and bottom layers into the vacuum forming equipment between the upper and lower mold halves. The method further includes substantially sealing the upper and lower mold halves from atmosphere, joining the top and bottom layers together to form an integral headliner, and applying vacuum to the top and/or bottom layers at predetermined locations so as to form cavities between the top and bottom layers. The headliner made by the aforementioned method includes a plurality of surface contours on its top and/or bottom layers defining convex and concave members for absorption of impact energy during a crash.

### BACKGROUND OF INVENTION

This application claims benefit of priority of Provisional Application Serial No. 60/459,184, filed Apr. 1, 2003.

a. Field of Invention

The invention relates generally to headliners for use in the interior of vehicles, and, more particularly to headliners that achieve the requisite head impact compliance (HIC) for today's motor vehicles without the need for additional components attached thereon and a method of manufacturing the same.

b. Description of Related Art

Passenger cars, vans, buses, trucks, trains and airplanes, for example, generally include headliners mounted inside the passenger compartment for providing an aesthetic covering for the sheet metal and/or framework on which they may be mounted. Headliners are also provided for sound absorption, energy absorption and/or concealment of electrical wiring and HVAC vents.

Conventional headliners are generally constructed of a single layer or multiple layers of material joined together and mounted onto the roof sheet metal and/or associated framework. Such headliners are often made of materials, such as, particleboard, fiberboard, plastic board, fabric, and a variety of foams. For motor vehicles, such conventional existing headliners do not however meet the requisite federal head impact compliance standards, without additional components being affixed thereon.

In an attempt to meet these federal standards, various materials and configurations for headliners have been proposed and tested throughout the automotive industry. Although the effective head impact federal standards have been met by some existing headliner designs, such designs are nevertheless complex due to the attachment of additional components or due to the overall thickness of the multiple layers, expensive to manufacture and install, and do not provide adequate sound and/or other environmental insulation.

For example, as illustrated in FIG. 1, a conventional headliner 10 may include one or more polyurethane blocks 12 glued thereon in a secondary manufacturing operation for achieving the requisite federal head impact compliance standards. As discussed above, although this secondary operation imparts sufficient rigidity and compliance to headliner 10 to meet or even exceed the requisite federal head impact compliance standards, such a secondary operation is nevertheless economically prohibitive with regard to the overall costs associated with the design, testing, manufacturing and installation of the headliner.

Various conventional headliner designs and their associated methods of manufacture are known and disclosed, for example, in U.S. Pat. No. 6,500,369 to Gorowicz, U.S. Pat. No. 6,343,129 to Pelrine, U.S. Pat. No. 6,338,618 to Van Ert, U.S. Pat. No. 6,247,745 to Carroll, III, U.S. Pat. No. 6,199,942 to Carroll, III, U.S. Pat. No. 6,153,144 to Byma, U.S. Pat. No. 6,120,090 to Van Ert, U.S. Pat. No. 6,017,084 to Carroll, III, U.S. Pat. No. 5,888,616 to Ang and U.S. Pat. No. 5,007,976 to Satterfield, and U.S. Patent Application Publication Nos. 2002/0070584 to Carroll, III, 2002/0017805 to Carroll, III, 2002/0145236 to Wandyez and 2002/0142129 to Chaudhry, the respective disclosures of which are incorporated herein by reference.

Of the aforementioned U.S. Patents and Publications, an exemplary conventional method of making a headliner including integrated energy absorbing foam is disclosed in U.S. Pat. No. 6,500,369 to Gorowicz. The headliner for Gorowicz is formed of a plurality of layers including fiber-glass mat and urethane layers which are disposed in a mold and thereafter bonded together by the associated method of manufacture thereof. Alternatively, U.S. Patent Application Publication No. 2002/0145236 to Wandyez provides a blow molded headliner which is formed by molten parison being extruded into a blow mold having a desired shape for the exterior contour of the headliner substrate. For the headliners and associated methods of manufacture thereof disclosed by Gorowicz and Wandyez, while the headliners themselves are not formed of a twin sheeted structure in the context of the present invention, these conventional headliners further require the additional installation of components for meeting the aforementioned requisite federal head impact compliance standards. For the remaining U.S. Patents and Publications cited above, the aforementioned exemplary drawbacks likewise apply.

Accordingly, there remains a need for a vehicle headliner which meets the federal head impact compliance standards set forth for today's motor vehicles without the need for additional component installation, which is economically feasible to manufacture, install and service, and which is robust in design so as to provide adequate sound and/or other environmental insulation, as well as a desired aesthetic appearance.

### SUMMARY OF INVENTION

The invention solves the problems and overcomes the drawbacks and deficiencies of prior art headliner designs by providing a novel headliner that includes pockets integrally formed between adjacent layers of twin sheets and a method of manufacturing the same.

Thus, an exemplary aspect of the present invention is to provide a headliner design which meets the federal head impact compliance standards set forth for today's motor vehicles without the need for additional component installation.

Another aspect of the present invention is to provide a headliner design which is economically feasible to manufacture, install and service, and which is robust in design so as to provide adequate sound and/or other environmental insulation.

Yet another aspect of the present invention is to provide a twin sheeted structural thermoplastic headliner which achieves head impact compliance in a “one-step” manufacturing process.

Yet a further aspect of the present invention is to provide a headliner which is environmentally friendly to produce, which can reduce the need for secondary frame components for roof mounted consoles, which can create HVAC duct work in the one-step manufacturing process, and which could eliminate roof bows.

The invention achieves the above-identified exemplary aspects by providing a method of manufacturing a headliner for a vehicle. The method includes the steps of providing vacuum forming equipment including upper and lower mold halves, providing thermoplastic material including at least one top and at least one independent bottom layer, and placing the top and bottom layers into the vacuum forming equipment adjacent forming surfaces of the upper and lower mold halves. The method further includes the steps of substantially sealing at least one of the upper and lower mold halves from atmosphere, joining the top and bottom layers together to form an integral headliner, and applying vacuum to at least one of the top and bottom layers at predetermined locations so as to form at least one cavity between the top and bottom layers.

For the method described above, the steps of providing vacuum forming equipment, providing thermoplastic material, placing, sealing, joining and applying are carried out to thereby provide a head impact compliant headliner for motor vehicles without attachment of additional components on the headliner. The step of applying provides surface contours on the top and/or bottom layers defining convex and concave members for increasing structural performance. The method further includes the step of injecting other components, such as foam for example, between the top and bottom layers for increasing structural performance. At least one of the convex and concave members are in the shape of a waffle, cone, conical section, pyramid, truncated pyramid, rectangular solid, rectangle, cube, sphere, spheroid, ellipse, truncated ellipse, rhombohedral solid, and/or truncated rhombohedral solid. Optimally, at least one of the convex and concave members are in shape of an hexagon, circle, triangle and/or square solid.

The invention also provides a headliner for a vehicle made by the aforementioned method, with the headliner including at least one top layer including a plurality of surface contours, at least one bottom layer including a plurality of surface contours, and the top and bottom layers substantially joined together and including at least one area therebetween defining at least one cavity.

The invention yet further provides a headliner for a vehicle, which includes at least one top layer including a plurality of surface contours, at least one bottom layer including a plurality of surface contours, and the top and bottom layers being substantially joined together to form an integral headliner including at least one area between inner surfaces of the top and bottom layers defining a cavity. The top layer is independent from the bottom layer prior to being joined to the bottom layer.

For the headliner described above, the headliner is head impact compliant for motor vehicles without attachment of additional components on the headliner. The surface contours of the top and/or bottom layers define convex and concave members for absorption of impact energy. The headliner further includes other components, such as foam for example, injected between the top and bottom layers for increasing structural performance. At least one of the convex and concave members is in the shape of a waffle, cone, conical section, pyramid, truncated pyramid, rectangular solid, rectangle, cube, sphere, spheroid, ellipse, truncated ellipse, rhombohedral solid, and/or truncated rhombohedral solid. Optimally, at least one of the convex and concave members are in shape of an hexagon, circle, triangle and/or square solid.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an isometric view of a related art headliner design including polyurethane blocks mounted thereon;

FIG. 2 is an isometric view of the twin sheet headliner according to the present invention;

FIG. 3 is an enlarged isometric view of the twin sheet headliner of FIG. 2;

FIG. 4 is a top view of the twin sheet headliner of FIG. 2;

FIG. 5 is a cross-sectional view of the twin sheet headliner of FIG. 2, taken along Section 5-5 in FIG. 4;

FIG. 6 is a side view illustrating a manufacturing mold configuration for the twin sheet headliner of FIG. 2; and

FIG. 7 is a graph illustrating the performance of convex/concave members of various shapes.

### DETAILED DESCRIPTION

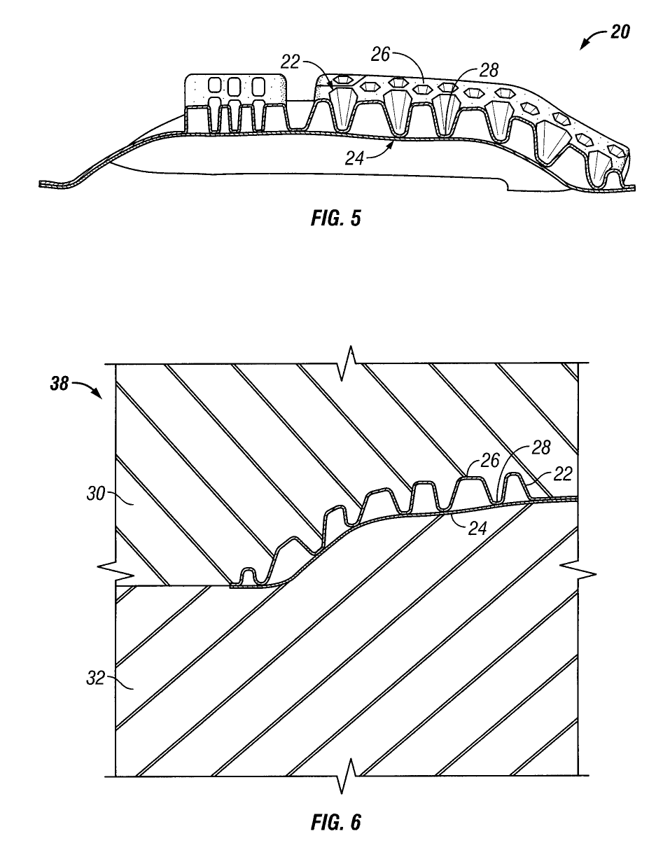

Referring now to the drawings wherein like reference numerals designate corresponding parts throughout the several views, FIGS. 2-5 illustrate a twin sheet headliner according to the present invention, generally designated “headliner 20.”

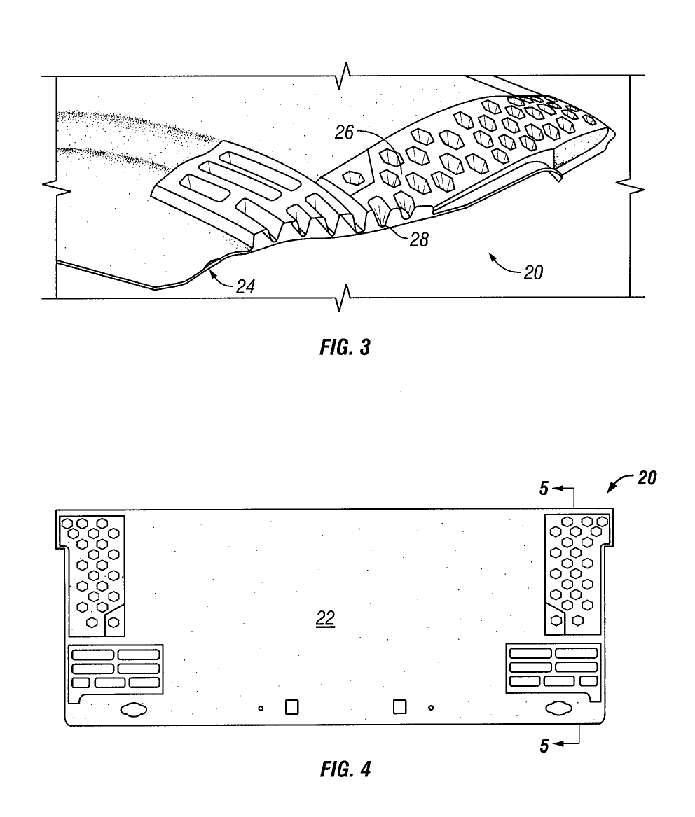

As shown in the embodiment of FIGS. 2 and 3, headliner 20 may be formed of a twin sheet thermoplastic substrate including an upper or top layer 22 and a lower or bottom layer 24. The thermoplastic substrate may be a material such as polypropylene/fiberglass mat, or another thermoplastic and equivalent materials known in the art. In the embodiment of FIG. 2, top layer 22 may be made of an energy absorbing sheet, and bottom layer 24 may be made of a Class-A type sheet for facilitating attachment of material such as cloth or carpeting thereon. Headliner 20 may include a length-L and a width-W, which may each be dimensioned as needed for installation of headliner 20 under the associated sheet metal of an automobile. As illustrated in FIG. 3, the thickness of headliner 20 varies across the length-L and width-W as a function of the desired head impact absorption characteristics at predetermined locations on the headliner. For example, the thickness of headliner 20 at location 40, which may be disposed adjacent a windshield of an automobile, may be thicker than the thickness at location 42, disposed aft of the windshield.

Referring next to FIGS. 2-5, headliner 20 may include respective convex and concave members 26, 28 formed therein for absorption of impact energy during a crash and the like. Members 26, 28 may be shaped in various forms and are configured to absorb energy in a predetermined manner. For example, members 26, 28 may be formed in the shape of various geometric solids and sizes depending on the amount and types of energy to be dissipated. In the particular embodiment of FIGS. 2 and 3, members 26, 28 in combination may be formed of such shapes as waffles, cones, conical sections, pyramids, truncated pyramids, rectangular solids, rectangles, cubes, spheres, spheroids, ellipses, truncated ellipses, rhombohedral solids, truncated rhombohedral solids, etc.

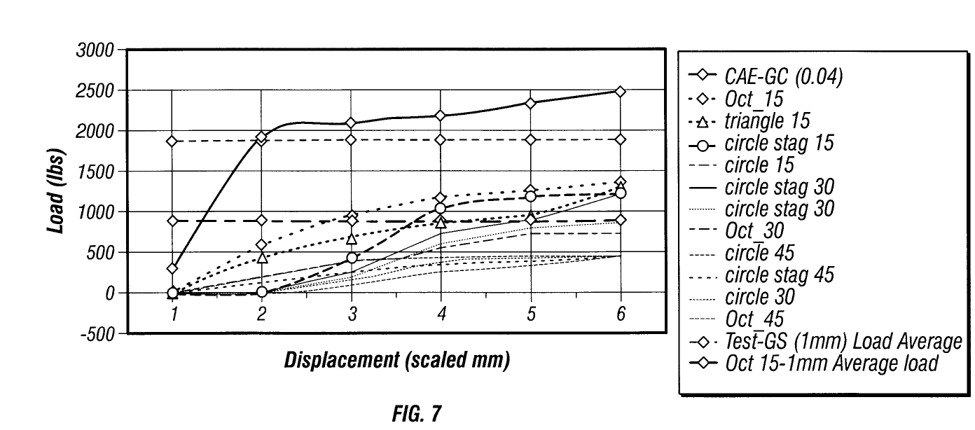

In order to determine the optimal shapes for absorption of impact energy, there has been extensive analysis and tests conducted herein on several of the aforementioned shapes for characteristics such as displacement and load absorption. For example, as illustrated in FIG. 7, there have been extensive tests performed herein on convex and concave members 26, 28 of various shapes including shapes such as hexagonal, triangular, circular etc. There have been further tests conducted herein for the aforementioned shapes with sheets of various thickness, as well as the effect of normal and angled impact on a particular shape. Based upon the aforementioned analysis and tests performed herein, it has been determined that convex and concave members 26, 28 may optimally include an hexagonal, circular, triangular or square shape for maximum impact energy absorption.

For the specific embodiment of FIG. 2, convex members 26 may include a hollow interior portion (not shown) which assists in the absorption and dispersal of energy from an impact and the like, and such features can be achieved in the one-step manufacturing process of the present invention, as discussed in detail below. Alternatively, convex members 26 may include other components, such as foam (not shown) for example, injected within the space formed between top and bottom layers 22, 24 so as to provide additional absorption and dispersal of energy from an impact and the like. As discussed in detail below, the foam may be injected within the cavity formed between top and bottom layers 22, 24 during a secondary manufacturing step, or alternatively, provisions may be made for injection of the foam during the manufacture of headliner 20.

The method of manufacture for headliner 20 according to the present invention will now be described in detail in reference to FIGS. 2-6, and especially FIG. 6.

Specifically, as illustrated in FIG. 6, in order to manufacture headliner 20, the substrate including top and bottom layers 22, 24 may be heated in an oven (not shown) and thereafter placed in mold 38 including upper and lower halves 30, 32. Mold 38, provided in a standard vacuum forming machine (not shown), may be sealed with top and bottom layers 22, 24 being disposed therein. A vacuum means (not shown) may then be used to draw vacuum from upper half 30 of mold 38 so as to reconfigure top layer 22 to include convex and concave members 26, 28 which match the inner surface of halves 30, 32. Alternatively, if needed, a vacuum means (not shown) may be used to draw vacuum from lower half 32, or both upper and lower halves 30, 32, of mold 38 so as to reconfigure top and/or bottom layers 22, 24 to include convex and concave members similar to members 26, 28.

Once set within mold 38 and allowed to cool, headliner 20 may be removed and adequately trimmed if needed. As discussed above, once removed from mold 38, foam may be injected within the cavity formed between top and bottom layers 22, 24 of convex members 26 so as to provide additional absorption and dispersal of energy from an impact and the like. The foam may be injected by standard openings (not shown) pre-formed during the manufacture of headliner 20, or alternatively, formed after the manufacture of headliner 20.

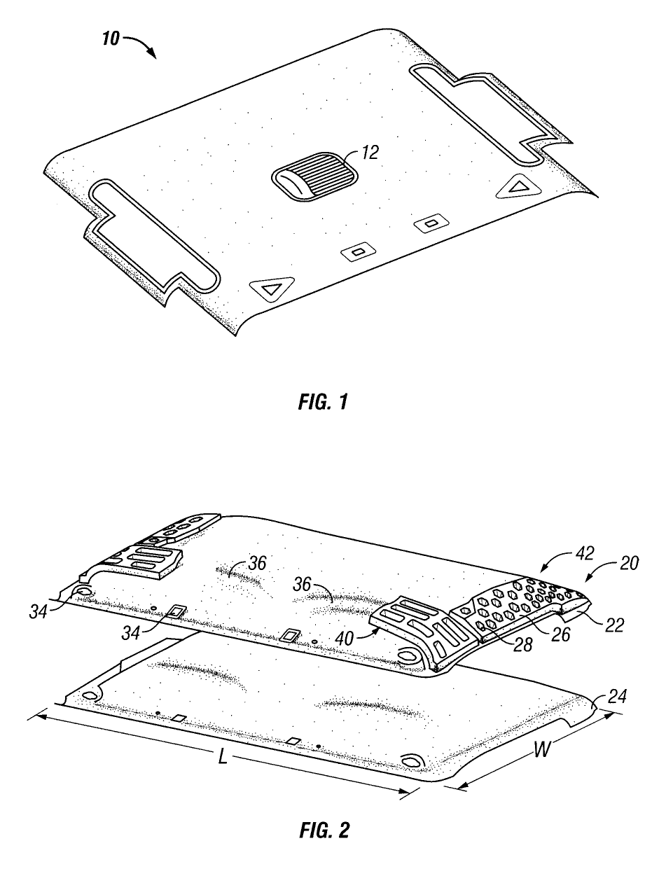

The manufacturing method for headliner 20 thus provides a “one-step” method by which a complete headliner may be formed and yet attain the requisite federal head impact compliance standards. Moreover, by using the aforementioned manufacturing process, additional components such as polyurethane foam blocks (as described above in reference to FIG. 1), “O” flex crush tubes, and the Dow strand foam blocks, which are currently used on automotive headliners for achieving the requisite federal head impact compliance standards, can be eliminated by the one piece headliner 20. Headliner 20 thus eliminates the secondary operations required to attach purchased in assembly (PIA) components to headliner assemblies for achieving the requisite head impact compliance.

In a further modification of headliner 20, upper and lower halves 30, 32 of mold 38 may be configured to form top and bottom layers 22, 24 of headliner 20 with through-zones 34 for facilitating the installation of headliner 20 onto the associated sheet metal of an automobile by means of retainers (not shown) fitting into associated connections (not shown) in the sheet metal. In this manner, the method of the present invention can reduce the need for secondary brackets for roof mounted consoles/DVD players, etc., by permitting such additional devices to be connected directly into respectively configured through-zones 34. Additionally, headliner 20 may be molded with predetermined contours and channels, such as contours 36 to create a HVAC duct by the one-step molding process. Moreover, a specified amount of foam may be injected between top and bottom layers 22, 24 to eliminate roof bows and to contour the exposed surface of bottom layer 24 as needed. Headliner 20 of the present invention may also be tuned to achieve specific acoustic and deformation performance criteria by varying factors such as the gram weight of the thermoplastic material, as well as the various contours of top and bottom layers 22, 24.

In a related manufacturing method for headliner 20 of the present invention, a twin cavity mold (not shown) may be utilized to manufacture two headliners at a time with the rear edges thereof being common. The manufacturing method employing the twin cavity mold would further reduce the blank size, scrap, trimming cycle time and labor required per headliner produced.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

1. A method of manufacturing a headliner for a vehicle, said method comprising the steps of:
providing vacuum forming equipment including upper and lower mold halves;
providing thermoplastic material including at least one top and at least one independent bottom layer;
placing said top and bottom layers into the vacuum forming equipment adjacent forming surfaces of the upper and lower mold halves;
substantially sealing at least one of the upper and lower mold halves from atmosphere;
joining said top and bottom layers together to form an integral headliner; and
applying vacuum to at least one of said top and bottom layers at predetermined locations so as to form at least one cavity between said top and bottom layers.

2. The method according to claim 1, wherein said steps of providing vacuum forming equipment, providing thermoplastic material, placing, sealing, joining and applying are carried out to thereby provide a head impact compliant headliner for motor vehicles without attachment of additional components on said headliner.

3. The method according to claim 1, wherein said step of applying provides surface contours on said top layer defining convex and concave members for absorption of impact energy.

4. The method according to claim 1, wherein said step of applying provides surface contours on said bottom layer defining convex and concave members for absorption of impact energy.

5. The method according to claim 1, further comprising the step of:
injecting other components between said top and bottom layers for increasing structural or function vehicle performance.

6. The method according to claim 3, wherein at least one of said convex and concave members being in shape of at least one hexagon, circle, triangle and square solid.

7. The method according to claim 4, wherein at least one of said convex and concave members being in shape of at least one hexagon, circle, triangle and square solid.

8. The method according to claim 3, wherein at least one of said convex and concave members being in shape of at least one waffle, cone, conical section, pyramid, truncated pyramid, rectangular solid, rectangle, cube, sphere, spheroid, ellipse, truncated ellipse, rhombohedral solid, and truncated rhombohedral solid.

9. The method according to claim 4, wherein at least one of said convex and concave members being in shape of at least one waffle, cone, conical section, pyramid, truncated pyramid, rectangular solid, rectangle, cube, sphere, spheroid, ellipse, truncated ellipse, rhombohedral solid, and truncated rhombohedral solid.

10. The method according to claim 1, wherein said headliner is made of thermoplastic.

11. A headliner for a vehicle made by the method of claim 1, said top and bottom layers including a plurality of surface contours, and said top and bottom layers substantially joined together and including at least one area therebetween defining said at least one cavity.

12. A headliner for a vehicle, said headliner comprising:
at least one top layer including a plurality of surface contours;
at least one bottom layer including a plurality of surface contours; and
said top and bottom layers being substantially joined together to form an integral headliner including at least one area between inner surfaces of said top and bottom layers defining a cavity,
wherein said top layer is independent from said bottom layer prior to being joined to said bottom layer.

13. The headliner according to claim 12, wherein said headliner is head impact compliant for motor vehicles without attachment of additional components on said headliner.

14. The headliner according to claim 12, wherein said surface contours of said top layer define convex and concave members for absorption of impact energy.

15. The headliner according to claim 12, wherein said surface contours of said bottom layer define convex and concave members for absorption of impact energy.

16. The headliner according to claim 12, further comprising:
other components injected between said top and bottom layers for increasing structural or function vehicle performance.

17. The headliner according to claim 14, wherein at least one of said convex and concave members being in shape of at least one hexagon, circle, triangle and square solid.

18. The headliner according to claim 15, wherein at least one of said convex and concave members being in shape of at least one hexagon, circle, triangle and square solid.

19. The headliner according to claim 14, wherein at least one of said convex and concave members being in shape of at least one waffle, cone, conical section, pyramid, truncated pyramid, rectangular solid, rectangle, cube, sphere, spheroid, ellipse, truncated ellipse, rhombohedral solid, and truncated rhombohedral solid.

20. The headliner according to claim 15, wherein at least one of said convex and concave members being in shape of at least one waffle, cone, conical section, pyramid, truncated pyramid, rectangular solid, rectangle, cube, sphere, spheroid, ellipse, truncated ellipse, rhombohedral solid, and truncated rhombohedral solid.

21. The headliner according to claim 12, wherein said headliner is made of thermoplastic.
